(19) United States
(12) Patent Application Publication
(10) Pub. No.: US 2010/0091456 A1
(43) Pub. Date: Apr. 15, 2010

(54) COMPUTER CASING

(75) Inventor: Yi-Chung Chang, Taipei (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: ASUSTEK COMPUTER INC., Taipei (TW)

(21) Appl. No.: 12/559,505

(22) Filed: Sep. 15, 2009

(30) Foreign Application Priority Data
Oct. 9, 2008 (TW) 97138953

(51) Int. Cl. G06F 1/16

(52) U.S. Cl. 361/679.58

(57) ABSTRACT

A computer casing including a main casing, a cover, a fluid cylinder and a first connecting element is provided. The main casing has a front panel. The fluid cylinder with a rod is disposed in the main casing. The rod is suitable for moving between a first position and a second position. The first connecting element has a first end, a second end and a pivoted portion. The first end connects to the rod, and the second end connects to the cover. The pivoted portion is located between the first end and the second end, and the first connecting element is pivotally connected to the main casing via the pivoted portion. When the rod locates at the first position, the cover is substantially meeting the front panel. When the rod locates at the second position, the cover is far away from the front panel.

### CROSS-REFERENCE TO RELATED APPLICATION

This application claims the priority benefit of Taiwan application serial no. 97138953, filed Oct. 9, 2008. The entirety of the above-mentioned patent application is hereby incorporated by reference herein and made a part of specification.

### BACKGROUND OF THE INVENTION

1. Field of the Invention

The present invention relates to a casing, specifically to a computer casing.

2. Description of Related Art

With the rapid development of electronic industry, the exterior design of consumer electronic device has gradually become a key factor when launching a product into the market. As for the more mature electronic products, the industrial design of appealing configuration has gradually replaced the demand for function and becomes the main concern for consumers while purchasing; personal computer is one of the evident examples. Considering the limited differences in function and processing speed between most of the products in the market, the design of computer casing has become a major point in product development: a computer casing with more appealing configuration and more convenience in use is likely to be the mainstream of consumers' choices in the market.

The conventional computer casing pivotally connects a cover on a front panel to conceal a CD-ROM and other peripherals exposed by the front panel for an uniform exterior presentation.

For some of the conventional computer casings, a user needs to lift up the cover relative to the front panel when utilizing the peripherals hidden under the cover. After utilization of the peripherals, the user replaces the cover over the front panel manually. As for another conventional computer casing, a torsion spring structure is disposed between the cover and the front panel for pushing to lift up a cover relative to the front panel. Moreover, the cover and the front panel are each disposed with a latch structure. When a user is utilizing the peripherals under the cover, the user disengages the interference of the latch structure manually or by a detaching button. After disengagement of the latch, the cover is driven by the torsion spring structure to lift up rapidly.

However, in the above descriptions of lifting up the cover of a computer casing manually or with the torsion spring structure, the traveling time and speed of the cover relative to the front panel are affected by the strength enforced by the user or the elasticity of the torsion spring structure and therefore difficult to control. Therefore, the process of lifting the cover corresponding to the front panel may result in rapid lifting or bounding due to excessive force applied by the user or exceeding elasticity in the torsion spring structure. As a result, the connection structure between the cover and the front panel may be damaged by inappropriate external force.

### SUMMARY OF THE INVENTION

The present invention provides a computer casing, having a cover which moves away or meets a front panel relative thereto at a slower speed.

The present invention provides a computer casing including a main casing, a cover, a fluid cylinder, and a first connecting element. The main casing has a front panel. The fluid cylinder, having a rod, is disposed in the main casing. The rod is suitable for moving between a first position and a second position. The first connecting element has a first end, a second end, and a pivoted portion. The first end connects the rod, the second end connects the cover, and the pivoted portion is located between the first end and the second end. The first connecting element is pivotally connected to the main casing via the pivoted portion. When the rod locates at the first position, the cover substantially meets on the front panel. When the rod locates at the second position, the cover moves away from the front panel.

In one embodiment of the present invention, the computer casing further includes a first magnetic device and a second magnetic device. The first magnetic device is disposed in the front panel. The second magnetic device is disposed in the cover. As the cover substantially meets to the front panel, the first magnetic device is magnetically attracted to the second magnetic device.

In one embodiment of the present invention, the first connecting element is comprised of a pivot, a first linkage, and a second linkage. The pivot has the pivoted portion. The first linkage has the first end, and a third end corresponding to the first end, and the third end links to the pivot. The second linkage has the second end, and a fourth end corresponding to the second end, and the fourth end links to the pivot. The first linkage and the second linkage maintain at the fixed relative positions.

In one embodiment of the present invention, the computer casing further includes a second connecting element fixed to a rod, and a guiding slot. The first end of the first connecting element slidingly disposed in the guiding slot.

In one embodiment of the present invention, the computer casing further includes a third connecting element having a first linking part and a second linking part. The first linking part is pivotally connected to the front panel and the second linking part is slidingly disposed at the cover.

In one embodiment of the present invention, the cover has a guiding slot, and the third connecting element has a protrusion in the guiding slot.

In one embodiment of the present invention, the computer casing further includes a torsion spring having a first end portion and a second end portion. The first end portion is against the third connecting element and the second end portion is against the front panel to drive the cover away from the front panel.

In one embodiment of the present invention, the fluid cylinder is an air cylinder or a hydraulic cylinder.

The cover of the computer casing in the present invention is connected to the first connecting element and the rod in the fluid cylinder, so the fluid cylinder provides a buffer as the cover moves to or away from the front panel. Therefore, the cover moves more gently and uniformly relative to the front panel, which avoids damage of the first connecting element or collision of the cover and the front panel.

In order to make the aforementioned and other objects, features and advantages of the present invention more comprehensible, preferred embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic side view of a computer casing according to one embodiment of the present invention.

FIG. 2 is a schematic side view when the cover of the computer casing in FIG. 1 is away from the front panel.

FIG. 3 is a schematic three-dimensional view of the computer casing in FIG. 2.

FIG. 4 is a relative relationship diagram among the torsion spring, the third connecting element, and the front panel in FIG. 3.

### DESCRIPTION OF EMBODIMENTS

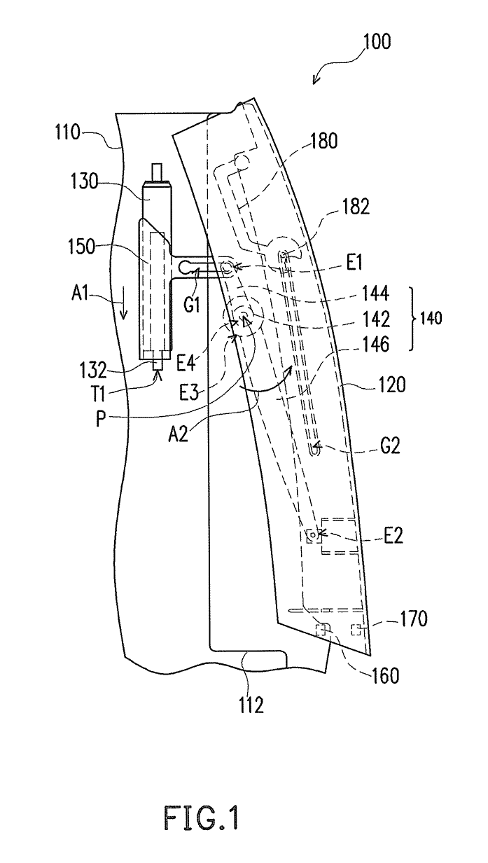

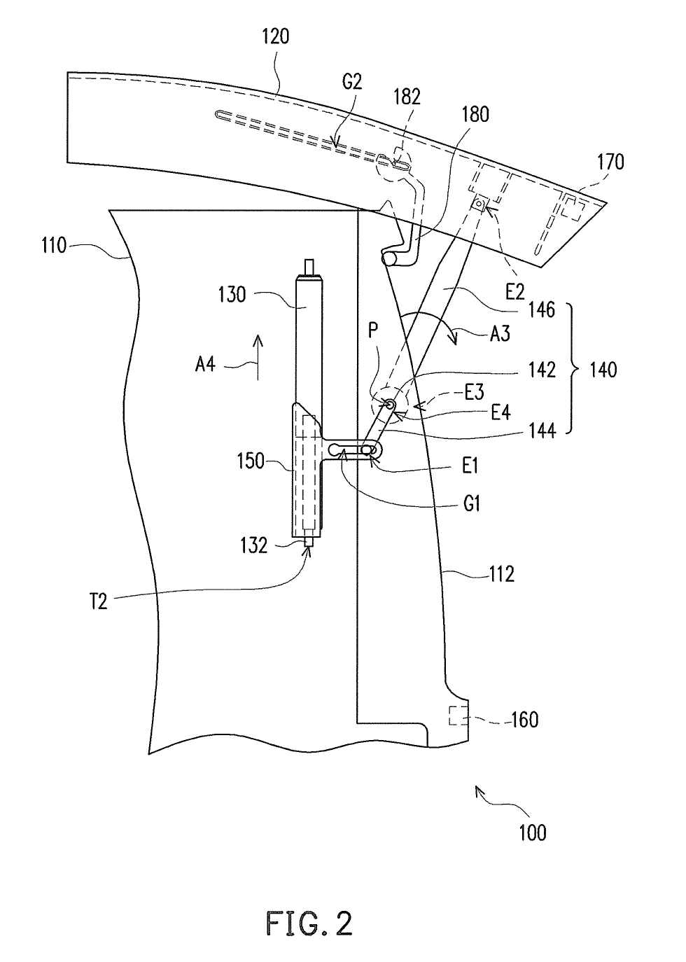

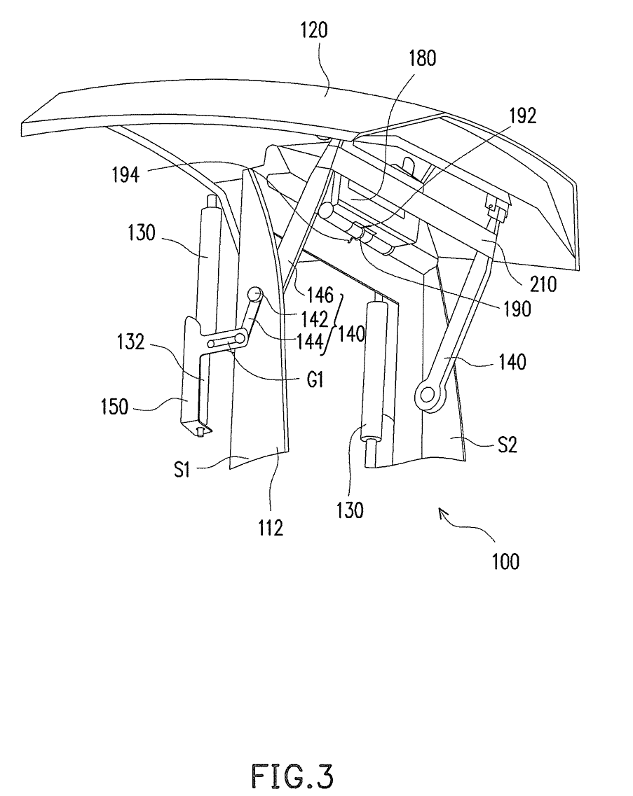

FIG. 1 is a schematic side view of the computer casing according to one embodiment of the present invention; FIG. 2 is a schematic side view when the cover of the computer casing in FIG. 1 is away from the front panel; FIG. 3 is a schematic three-dimensional view of the computer casing in FIG. 2. Referring to FIGS. 1-3, a computer casing 100 includes a main casing 110 (not shown in FIG. 3), a cover 120, a fluid cylinder 130, and a first connecting element 140. The main casing 110 has a front panel 112. The fluid cylinder 130, containing a rod 132, is disposed in the main casing 110. In the present embodiment, the fluid cylinder 130 may be an air cylinder or a hydraulic pressure cylinder. In other words, the fluid cylinder 130 may contain air or a damping material like hydraulic oil.

The rod 132 is suitable for moving between a first position T1 (as shown in FIG. 1) and a second position T2 (as shown in FIG. 2). When the rod 132 locates at the first position T1, most of the rod 132 is stored in the fluid cylinder 130. When rod 132 locates at the second position T2, the cover 120 is away from the front panel 112, and most of the rod 132 protrudes outside the fluid cylinder 130. For example, the elasticity provided by the fluid cylinder 130 allows most of the rod 132 to protrude outside the fluid cylinder 130. When a user presses the cover 120 to make a connecting element with the front panel 112, the rod 132 is affected by an external force opposite to the elastic force, and moves from the second position T2 to the first position T1, so that most of the rod 132 is stored in the fluid cylinder 130.

The first connecting element 140 has a first end E1, a second end E2, and a pivoted portion P. The pivoted portion P is located between the first end E1 and the second end E2 while the first connecting element 140 is pivotally connected to the main casing 110 through the pivoted portion P. In the present embodiment, the computer casing 100 further includes a second connecting element 150. The first connecting element 140 connects to the second connecting element 150, and the second connecting element 150 is fixed to the rod 132. That is, the first connecting element 140 is linked to the rod 132 through the second connecting element 150. In detail, the second connecting element 150 has a guiding slot G1, and the first end E1 of the first connecting element 140 is slidingly disposed in the guiding slot G1. Also, in another embodiment, the rod 132 is intergrally formed with the second connecting element 150, so that the first end E1 of the first connecting element 140 directly links to the rod 132, and the second end E2 links to the cover 120.

Please refer to FIG. 1 and FIG. 2 sequentially. As the rod 132 moves from the first position T1 to the second position T2, the rod 132 protrudes outside the fluid cylinder 130. At this time, the second connecting element 150 is affected by the rod 132, and moves along the direction of a first arrow A1. In the movement of the second connecting element 150, the structure surrounding the guiding slot G1 and the first end E1 of the first connecting element 140 interfere with each other, such that the first connecting element 140 pivots along the direction of a second arrow A2. Therefore, the second end E2 of the first connecting element 140 drives the cover 120 away from the front panel 112.

More specifically, when the rod 132 locates at the first position T1, the first end E1 of the first connecting element 140 is located at a terminal end of the guiding slot G1. As the first connecting element 140 pivots along the direction of the second arrow A2, the first end E1 first moves from the terminal end of the guiding slot G1, to the direction of the fluid cylinder 130 along the guiding slot G1. Next, the first end E1 of the first connecting element 140 then slides away from the fluid cylinder 130 along the guiding slot G1, and returns to the terminal end of the guiding slot G1. At this time, the rod 132 moves to the second position T2.

Furthermore, please refer to FIG. 2 and FIG. 1 sequentially. As the cover 120 moves towards the front panel 112, the cover 120 drives the first connecting element 140 to pivot along the direction of a third arrow A3. At this moment, the first end E1 of the first connecting element 140 and the surrounding structure of the guiding slot G1 interfere with each other and affect the second connecting element 150 to move along the direction of a fourth arrow A4. Following the movement of the second connecting element 150 along the direction of the fourth arrow A4, the rod 132 moves from the first position T1 to the second position T2 and allows the cover 120 to cover the front panel 112 substantially.

Notably, since the fluid cylinder 130 contains damping material like air or a hydraulic oil, So, when the rod 132 is moving between the first position T1 and the second position T2, the interference between the rod 132 and the damping material in the fluid cylinder 130 provides a buffer and results in a more uniform moving speed for the rod 132. As a consequence, when the rod 132 moves from the first position T1 to the second position T2, the cover 120 gently lifts away from the front panel 112 at a stable speed, and a linking structure between the cover 120 and the front panel 112 receives a more even force. Moreover, when covering the cover 120 on the front panel 112, the user exerts force and makes the first connecting element 140 drive the second connecting element 150, while the second connecting element 150 applies a force on the rod 132 until the cover 120 meets on the front panel 112. At this time, the fluid cylinder 130 provides a buffering effect to prevent the cover 120 from rapidly pressing downwards and damaging the front panel 112. That is, when the cover 120 is moving towards the front panel 112, the fluid cylinder 130 provides a buffering force to slow down the moving speed of the cover 120 and consequently avoiding possible collision resulting from high moving speed of the cover 120. Furthermore, the first connecting element 140 includes a pivot 142, a first linkage 144, and a second linkage 146. The pivot 142 has a pivoted portion P. The first linkage 144 has a first end E1 and a third end E3 corresponding to the first end E1, and the third end E3 is linked to the pivot 142. The second linkage 146 has a second end E2, and a fourth end E4 corresponding to the second end E2, and the fourth end E4 is linked to the pivot 142. The first linkage 144 and the second linkage 146 maintain at the fixed relative positions. That is, when the first linkage 144 pivots around the pivot 142, the second linkage 146 is driven by the first linkage 144, and the two linkages pivot synchronously. In the present embodiment, the first linkage 144 and the fluid cylinder 130 are located at a side wall S1 (FIG. 3) of a side of the front panel 112 while the second linkage 146 is located at the other side of the side wall S1. When the front panel 112 and the main casing 110 are assembled, rather than exposing on the outside, the first linkage 144 and the fluid cylinder 130 are covered under the main casing 110, and thereby improving the uniform configuration of the computer casing 100 for a more appealing appearance.

Additionally, the computer casing 100 further includes a first magnetic device 160 and a second magnetic device 170. The first magnetic device 160 is disposed in the front panel 112. The second magnetic device 170 is disposed in the cover 120. As the cover 120 substantially meets the front panel 112, the first magnetic device 160 is magnetically attracted to the second magnetic device 170 so as to maintain at the relative positions of the cover 120 and the front panel 112. That is, the user only needs to exert a slight force on the cover 120 to resist the magnetic force between the first magnetic device 160 and the second magnetic device 170 to relieve the bonding between the cover 120 and the front panel 112. After relieving the bonding of the cover 120 and the front panel 112, the rod 132 of the fluid cylinder 130 drives the second connecting element 150, which in turn drives the first connecting element 140 to move the cover 120, achieving the goal of semi-automatic lifting in a much less labor consuming way. In the present embodiment, the first magnetic device 160 and the second magnetic device 170 are a metal piece and a magnet respectively; however, in another embodiment not shown here, the first magnetic device 160 and the second magnetic device 170 may both be magnets.

Also, the computer casing 100 may further include a third connecting element 180 pivotally disposed at the front panel 112, and slidingly connected to the cover 120. In the present embodiment, the cover 120 has a guiding slot G2, and the third connecting element 180 has a protrusion 182 slidingly disposed in the guiding slot G2. As the cover 120 moves close to or away from the front panel 112, the protrusion 182 of the third connecting element 180 and the surrounding structure of the guiding slot G2 provide interference and guidance to result in smoother movement of the cover 120. When the cover 120 relative to the front panel 112 is lifted, the cover 120 is supported by the third connecting element 180 to sustain enough space from the front panel 112 so as to avoid collision between the cover 120 and the front panel 112.

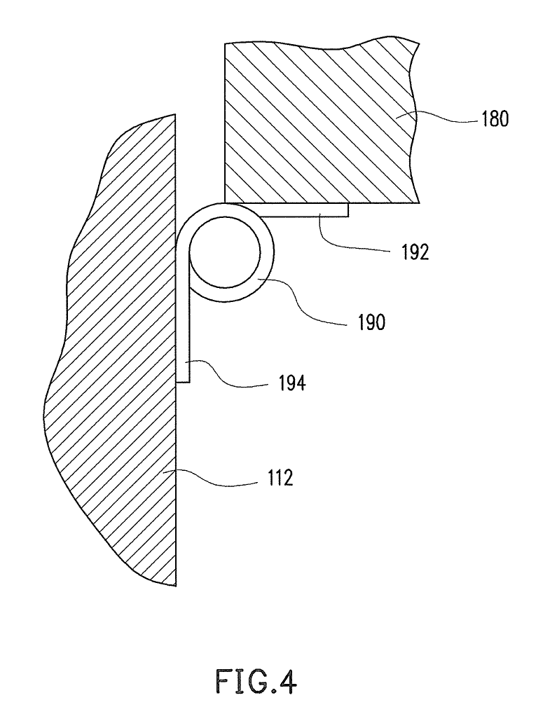

FIG. 4 is a schematic relative relationship diagram among the torsion spring, the third connecting element, and the front panel in FIG. 3. Referring to FIG. 3 and FIG. 4, in detail, the computer casing 100 further includes a torsion spring 190, disposed between the third connecting element 180 and the front panel 112. The torsion spring 190 has a first end portion 192 and a second end portion 194. The first end portion 192 is against the third connecting element 180 and the second end portion 194 is against the front panel 112 so that the cover 120 is driven away from the front panel 112. When the cover 120 receives a force and meets on the front panel 112, the torsion spring 190 generates a greater elastic deformation. On the contrary, as the cover 120 corresponding to the front panel 112 is lifted open, the torsion spring 190 would drive the third connecting element 180 with the rebound force produced by the elastic deformation, and consequently drives the cover 120 away from the front panel 112.

Moreover, the present embodiment may further include the fluid cylinder 130 and the second connecting element 150 disposed at a side wall S2 of the other side of the front panel 112. Also, the two second connecting elements 150 on the side walls S1 and S2 may be connected through a fourth connecting element 210 to unify the pivoting of the two second connecting elements 150.

In summary, in the computer casing of the present invention, during the process of the cover moving towards or away from the front panel, the first connecting element and the rod in the fluid cylinder are linked together, so the fluid cylinder provides a buffering force for the cover in movement. Therefore, the cover relative to the front panel of the computer casing of present invention moves at a more gentle and uniform speed, and applies an even force on the linking structure between the cover and the front panel while avoiding damage of the linking structure or collision between the cover and the front panel.

Though the present invention has been disclosed above by the embodiments, they are not intended to limit the present invention. Anybody skilled in the art can make some modifications and variations without departing from the spirit and scope of the present invention. Therefore, the protecting range of the present invention falls in the appended claims.

What is claimed is:

1. A computer casing, comprising:
a main casing, having a front panel;
a cover;
a fluid cylinder, disposed in the main casing and having a rod, wherein the rod is suitable for moving between a first position and a second position; and
a first connecting element, having a first end, a second end, and a pivoted portion, wherein the first end links to the rod, the second end links to the cover, and the pivoted portion is located between the first end and the second end, the first connecting element being pivotally connected to the main casing via the pivoted portion, the cover is substantially meeting the front panel when the rod is located at the first position, the cover being away from the front panel when the rod locates at the second position.

2. The computer casing according to claim 1, further comprising:
a first magnetic device, disposed in the front panel; and
a second magnetic device, disposed in the cover, wherein when the cover substantially meets on the front panel, the first magnetic device is magnetically attracted to the second magnetic device.

3. The computer casing according to claim 1, wherein the first connecting element comprises:
a pivot, having the pivoted portion;
a first linkage, having the first end and a third end corresponding to the first end, wherein the third end links to the pivot; and
a second linkage, having the second end and a fourth end corresponding to the second end, wherein the fourth end is connected to the pivot, and the first linkage and the second linkage maintain at the fixed relative positions.

4. The computer casing according to claim 1, further comprising a second connecting element, fixed to the rod, and having a guiding slot, wherein the first end of the first connecting element is slidingly disposed in the guiding slot.

5. The computer casing according to claim 1, further comprising a third connecting element, having a first linking part and a second linking part, wherein the first linking part is pivotally disposed at the front panel, and the second linking part is slidingly disposed at the cover.

6. The computer casing according to claim 5, wherein the cover has a guiding slot, and the third connecting element has a protrusion slidingly disposed in the guiding slot.

7. The computer casing according to claim 5, further comprising a torsion spring, having a first end portion and a second end portion, wherein the first end portion is against the third connecting element and the second end portion is against the front panel to drive the cover away from the front panel.

8. The computer casing according to claim 1, wherein the fluid cylinder is an air cylinder or a hydraulic cylinder.
